(19) United States
(12) Patent Application Publication
(10) Pub. No.: US 2019/0225108 A1
(43) Pub. Date: Jul. 25, 2019

(54) METHOD AND SYSTEM OF SMART MANAGEMENT OF ELECTROCHEMICAL BATTERIES FOR AN ELECTRIC VEHICLE

(71) Applicant: BLUEBUS, Ergue Gaberic (FR)

(72) Inventors: Christian SELLIN, Concarneau (FR); Jean-Jacques JESTIN, Fouesnant (FR); Yvan AGNUS, Quimper (FR); Dominique HINGANT, Saint Yvi (FR); Tony TAN, Rennes (FR); Gilles BRUNET, Ploneis (FR); Michel THOMAS, Pouldreuzic (FR)

(73) Assignee: BLUEBUS, Ergue Gaberic (FR)

(21) Appl. No.: 16/307,122

(22) PCT Filed: Jun. 2, 2017
(86) PCT No.: PCT/EP2017/063542

§ 371 Date: Dec. 4, 2018

(30) Foreign Application Priority Data
Jun. 16, 2016 (FR) 1655624

(51) Int. Cl. B60L 58/12; B60L 58/24; B60L 58/22

(52) U.S. Cl. CPC B60L 58/12; B60L 58/24; B60L 2240/545; B60L 2200/18; B60L 58/22

(57) ABSTRACT

A process is provided for managing multiple rechargeable stores of electrical energy in an electric vehicle, arranged parallel to one another. The process includes a separation of the modules into at least two groups, and a power supply using one of the groups at a time. The process further includes a regulation phase within at least one group, called a passive group, including a power supply of at least one module, known as passive, of the passive group, which is supplied by at least one other module, known as functional, of the passive group. In addition, a system is provided implementing such a process and an electric vehicle implementing such a process or system.

The present invention relates to a method for intelligently managing the electrochemical batteries of an electric vehicle. It also relates to a system implementing such a method and an electric vehicle implementing such a method or such a system.

The field of the invention is the field of electric vehicles comprising several electrochemical batteries, in particular of the LMP® type (for “Lithium Metal Polymer”), mounted in parallel.

### STATE OF THE ART

Electric vehicles are known, supplied by several electricity storage modules mounted in parallel and each comprising one or more electrochemical batteries, in particular of the LMP® type. Each module delivers a high-voltage signal for supplying the electric motor(s) of the vehicle.

In order to provide an electric vehicle with sufficient range, several batteries are needed on board the vehicle, allowing storage of the electrical energy necessary for the desired range. Depending on the power desired for the drive train, and the power available from each battery, it may be necessary to use several batteries in parallel for supplying the drive train of the vehicle.

At the same time, it is known that electrochemical batteries are not suited to a slow discharge. In addition, in the case of batteries of the LMP® for “Lithium Metal Polymer”) type, it is necessary to maintain all of the batteries at a minimum operating temperature, in general greater than or equal to 80° C. In addition, when several batteries are used at the same time, it is preferable that each of these batteries has one and the same charge level.

However, at present there is no method for managing the rechargeable electrical energy storage modules of an electric vehicle, allowing all of these requirements to be met intelligently.

An aim of the present invention is to overcome this drawback.

Another aim of the invention is to propose a method for intelligently managing the electrical energy storage modules of an electric vehicle mounted in parallel.

It is also an aim of the invention to propose a method for managing the electrical energy storage modules of an electric vehicle, mounted in parallel, allowing the life span of said modules to be optimized, while still maintaining said modules ready for use at any moment.

### SUMMARY OF THE INVENTION

The invention makes it possible to achieve at least one of these aims by a method for managing a plurality of rechargeable electrical energy storage modules in an electric vehicle, said modules each comprising at least one rechargeable electrochemical battery, in particular of the LMP® type, and being arranged in parallel with one another, said method comprising:
separating said modules into at least two groups, and
supplying from one of said groups at once, in particular in turn, and even more particularly alternately;
   said method comprising, during supplying by a group, called active group, a phase called regulation phase within at least one group, called passive group, other than the active group, said regulation phase comprising supplying at least one module of said passive group by at least one other module, called operational module, of said passive group.

Thus, the method according to the invention proposes to separate, virtually, the rechargeable electrical energy storage modules into several groups, and use of one group at a time in order to carry out a supply. Thus, it is possible to apply rapid discharge cycles to each group and consequently to optimize the life span of each module.

In addition, when a group, called passive group, is not used then a module, called operational module, forming part of said passive group is used for supplying the other modules of this passive group in order to regulate them so as to maintain them ready for use.

In the present application, by “separation” is meant a virtual grouping of the modules, independently of their physical arrangement.

Preferentially, the regulation phase of a passive group can realise balancing of the charge level of at least one, and in particular each, module of said passive group.

For example, the regulation phase can carry out a discharge of the operational module in order to balance its remaining charge level with the remaining charge level of at least one other module of the passive group. In this case, the operational module can be used for supplying, for example, an auxiliary device of the vehicle, in particular external to the passive group.

Alternatively, or in addition, the operational module of the passive group can be used in order to balance the remaining charge levels of the modules of the passive group, for example by supplying at least one other module of the passive group. In this example, the operational module is discharged into at least one other module of the passive group for recharging said at least one other module of the passive group.

Alternatively or in addition, the regulation phase of a passive group can carry out temperature maintenance of at least one, and in particular each, module of said passive group.

In other words, the operational module of the passive group can be used in order to maintain heating in at least one, in particular all, of the modules of the passive group, including itself, to a temperature greater than or equal to a predetermined temperature.

When the regulation phase of a passive group carries out temperature maintenance, then the operational module of the passive group is used for supplying a heating means, such as a heating resistor or a heating circuit, of at least one, in particular of each, module of the passive group, including its own.

According to a particularly preferred version of the method according to the invention, for at least one passive group, the regulation phase can comprise a change-over, in particular in turn, of the operational module within the passive group.

Thus the method according to the invention makes it possible to carry out better management of the modules of the passive group.

Advantageously, the change-over can be carried out as a function of the remaining charge level (RCL) of each of the modules of the passive group.

In particular, the change-over can be carried out when the remaining charge level of the operational module becomes less than or equal to the remaining charge level of another module of the passive group, by a first predetermined value.

Advantageously, the first predetermined value can correspond to a percentage of a maximum charge capacity (MCC) or of a remaining charge level (RCL) of at least one of the modules of the passive group.

According to a first example embodiment, the first predetermined value can be constant.

For example, the first predetermined value can be equal to 5% of the MCC of a module.

According to another example embodiment, the first predetermined value can be variable.

More particularly, the first predetermined value can be a function of the remaining charge level of each module of the passive group.

In particular, the predetermined value can decrease when the remaining charge level of each module of the passive group decreases.

According to a non-limitative example embodiment, the first predetermined value can be equal to:
5% of the MCC of a module of the passive group when all the modules of said passive group have a RCL greater than 70% of the MCC;
4% of the MCC of a module of the passive group when at least one module of said passive group has a RCL comprised between 50% and 70% of the MCC;
3% of the MCC of a module of the passive group when at least one module of said passive group has a RCL comprised between 30% and 50% of the MCC; and
2% of the MCC of a module of the passive group when at least one module of said passive group has a RCL less than 30% of the MCC.

According to a non-limitative embodiment, the method according to the invention can comprise switching the supply from one group to another, carried out as a function of the remaining charge levels of said groups.

More particularly, switching from one group to another can be carried out when the remaining charge level of the active group is less than or equal to the remaining charge level of a passive group, in particular by a second predetermined value.

Advantageously, the second predetermined value can correspond to a percentage of a maximum charge capacity (MCC) or of a remaining charge level (RCL) of at least one of the groups.

According to a first example embodiment, the second predetermined value can be constant.

For example, the second predetermined value can be equal to 5% of the MCC of a group.

According to another example embodiment, the second predetermined value can be variable.

More particularly, the second predetermined value can be a function of the RCL of each group.

In particular, the second predetermined value can decrease when the RCL of each group decreases.

According to a non-limitative example embodiment, the second predetermined value can be equal to:
10% of the MCC of a group when all the groups have a RCL greater than 70% of the MCC;
8% of the MCC of a group when at least one group has a RCL comprised between 50% and 70% of the MCC;
5% of the MCC of a group when at least one group has a RCL comprised between 30% and 50% of the MCC;
3% of the MCC of a group when at least one group has a RCL less than 30% of the MCC.

In a preferred version, each group can comprise an identical number of modules.

The number of modules can be determined as a function of a desired total power during the supply step and of the power that can be delivered by each module.

In a preferred version, all the modules are identical, and each deliver one and the same nominal power.

Advantageously, the operational module of the passive group can also be used for supplying an auxiliary device within the electric vehicle, internally or externally to the passive group.

The method according to the invention can also comprise, for each module, measuring at least one, in particular each, of the following parameters:
a remaining charge level of said module, for example by a battery fuel gauge;
a temperature of said module, for example by a thermometer or a thermocouple; and/or
a voltage at the terminals of said module, for example by a voltmeter.

At least one of these parameters can be used for determining if switching, or respectively a change-over, to another group, respectively to another module of the passive group, must be carried out or not.

According to another aspect of the same invention, a system is proposed for managing a plurality of rechargeable electrical energy storage modules in an electric vehicle, said modules each comprising at least one rechargeable electrochemical battery, in particular of the LMP® type, and being arranged in parallel with one another, said system comprising:
for each module, a means for individual connection/disconnection, making it possible to place said module on discharge independently of the other modules, and
at least one controller for controlling, directly or indirectly, each of said means of connection/disconnection;
   said controller being configured in order to implement all the steps of the method according to the invention.

According to another aspect of the same invention, an electric vehicle is proposed, having on board a plurality of rechargeable electrical energy storage modules supplying said vehicle, said modules each comprising at least one rechargeable electrochemical battery, in particular of the LMP® type, and being arranged in parallel with one another, said modules being managed:
according to the method according to the invention; or
by a system according to the invention.

The vehicle according to the invention can for example be a public transport vehicle of the bus, coach or tyred tram type.

In the present invention, the term “tyred tram” denotes an electric public transport land vehicle mounted on wheels and which recharges at each station, so as to avoid the need for heavy infrastructure of the rails and catenaries type on the highway. Such an electric vehicle recharges at each station by means of charging elements of the station and a connector linking said vehicle to said station.

In the case of a vehicle of the tyred tram type, the vehicle can also comprise supercapacitors, to which the principle of the present invention is not applicable.

Switching the supply from one group to another can advantageously be carried out when the vehicle is stationary.

Thus, the vehicle according to the invention makes it possible to minimize any risks, or malfunctions, which could be associated with such switching when the vehicle is moving.

Similarly, the charge-over of the operational module in a passive group can advantageously be carried out when the vehicle is stationary.

### DESCRIPTION OF THE FIGURES AND EMBODIMENTS

Other advantages and characteristics will become apparent from the detailed description of embodiments which are in no way limitative, and the attached drawings, in which:

FIG. 1 is a diagrammatic representation of a non-limitative example of an electric vehicle according to the invention;

FIGS. 2a and 2b are diagrammatic representations of two non-limitative examples of parallel connection of the electrical energy storage modules of the vehicle in FIG. 1;

FIG. 3 is a diagrammatic representation, in the form of a flow chart, of a non-limitative example embodiment of the method according to the invention; and

FIGS. 4a-4f are representations of an example of the application of the method in FIG. 3 in the case of the vehicle in FIG. 1.

It is well understood that the embodiments that will be described hereinafter are in no way limitative. Variants of the invention can be considered in particular, comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

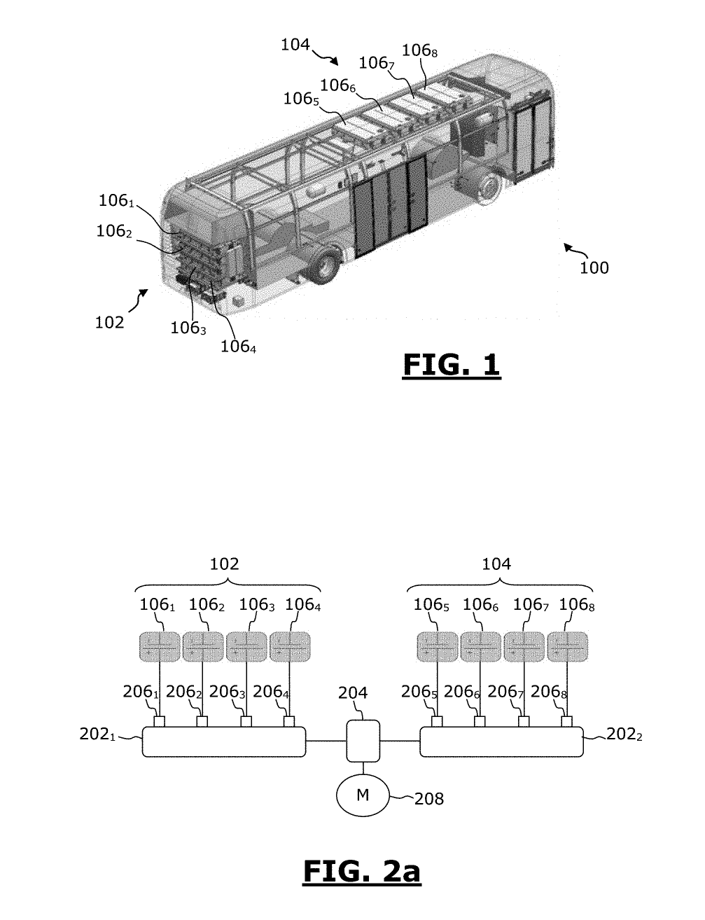

FIG. 1 is a diagrammatic representation of a non-limitative example of an electric vehicle according to the invention.

The electric vehicle 100 shown in FIG. 1 is an electric bus including one or more electric motors (not shown).

The vehicle comprises a first group 102 and a second group 104 each comprising four rechargeable electrical energy storage modules, namely modules 106₁-106₄ for the group 102 and modules 106₅-106₈ for the group 104. The group 102 is arranged on the side of a rear wall of the bus 100. The group 104 is arranged in a housing arranged on an upper wall of the bus 100.

The electric bus 100 is driven exclusively by the electrical energy supplied by the groups 102 and 104.

Each rechargeable electrical energy storage module 106 comprises one or more batteries of the LMP® (for “Lithium Metal Polymer”) type. The modules 106 are all identical and supply the same nominal power.

Each rechargeable electrical energy storage module 106 also includes a heating resistor (not shown) for heating said module, and which can be supplied independently.

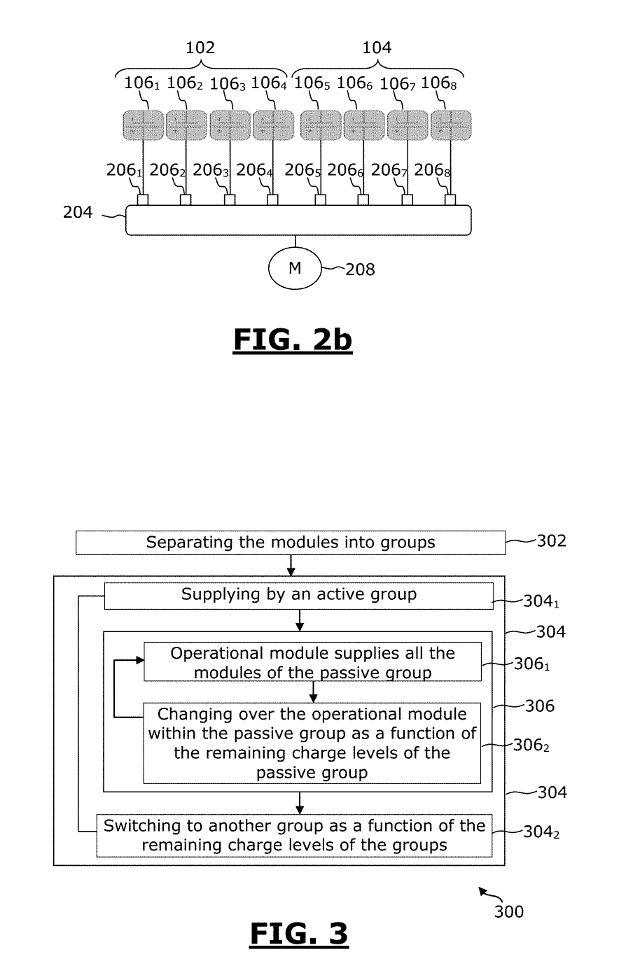

FIG. 2a is a diagrammatic representation of a non-limitative example of parallel connection of electrical energy storage modules in a vehicle according to the invention, in particular in the bus 100 in FIG. 1.

In the example shown in FIG. 2a, the modules 106₁-106₄ of the group 102 are connected to a management module 202₁, also called group controller, and the modules 106₅-106₈ of the group 104 are connected to a management module 202₂, also called group controller.

The group controllers 202₁ and 202₂ are in turn connected to a central controller 204, which itself is connected directly or indirectly to the electric motor(s) 208 with a view to supplying it (them) by the modules 106.

In particular, each module 106₁-106₄ of the group 102 is connected to the group controller 202₁ via a contactor, 206₁-206₄ respectively, that can be controlled by the group controller 202₁ or by the central controller 204. Similarly, each module 106₅-106₈ of the group 104 is connected to the group controller 202₂ via a contactor, 206₅-206₈ respectively, that can be controlled by the group controller 202₂ or by the central controller 204.

Each contactor 206ᵢ can be controlled individually by the central controller 204, directly or via group controllers 202₁-202₂, in order to be placed either in a closed state allowing the current supplied by the module 106ᵢ to pass, or in an open state preventing the passage of the current supplied by the module 106ᵢ.

The central controller 204 comprises:
a means (not shown) for measuring individually a remaining charge level (RCL) of each module 106,
a means (not shown) for measuring individually a temperature of each module 106, and/or
a means (not shown) for measuring individually a voltage at the terminals of each module 106.

The central controller 204 is also configured to compare each of the measured values for each module to one or more predetermined values or value ranges, in order to determine if said module is failing or operational.

Of course, measuring and comparing these parameters can alternatively be carried out by a unit other than the central controller program 204, such as for example by each group controller 202₁-202₂.

FIG. 2b is a diagrammatic representation of another non-limitative example of parallel connection of electrical energy storage modules in a vehicle according to the invention, and in particular in the bus 100 of FIG. 1.

The example shown in FIG. 2b comprises all the elements of the example in FIG. 2a, apart from the group controllers 202.

In the example shown in FIG. 2b, the modules 106₁-106₈ are directly connected to the central controller 204 by the contactors 206₁-206₈, without using the group controllers 202₁ and 202₂. The modules 106ᵢ are then all arranged in parallel with respect to one another.

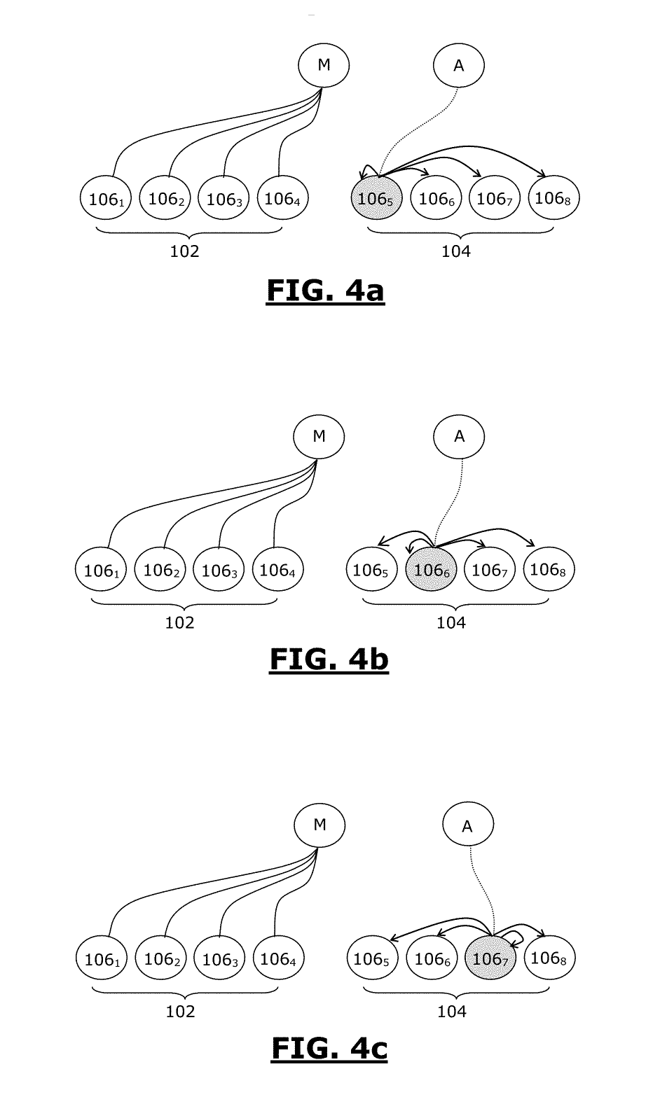

FIG. 3 is a diagrammatic representation of a first non-limitative example of a management method according to the invention.

The method 300, shown in FIG. 3, comprises a step 302 of separating the modules into several groups, for example into exactly two groups, such as the groups 102 and 104.

During this separation step 302, the physical arrangement of the modules can be taken into account for constituting the groups, for example as shown in FIG. 2a. Alternatively, it is possible not to take into account a physical arrangement of the modules, for example as shown in FIG. 2b.

During a step 304, the method 300 carries out an alternate supply from each of the groups in turn. To this end, a step 304₁ carries out a supply from one of the groups. The group in the process of supply is called active group and the other group(s) is(are) called passive group(s). The remaining charge level (RCL) of the active group is monitored during the supply step 304₁. Then, as a function of a predetermined rule, a step 304₂ carries out switching of the supply to another passive group, and so on.

Switching from one group to another, during step 304₂, can be carried out as a function of the remaining charge levels (RCL) of each group and the maximum charge capacity (MCC) of the groups.

In particular, switching from the active group to a passive group is carried out when the RCL of the active group becomes less than or equal to the RCL of a passive group by a predetermined value, which is equal to:
10% of the MCC of a group when all the groups have a RCL greater than 70% of the MCC;
8% of the MCC of a group when at least one group has a RCL comprised between 50% and 70% of the MCC;
5% of the MCC of a group when at least one group has a RCL comprised between 30% and 50% of the MCC; and
3% of the MCC of a group when at least one group has a RCL less than 30% of the MCC.

In the case of an electric vehicle, such as the bus 100 in FIG. 1, switching the supply from one group to another is preferentially carried out when the vehicle is stationary, in order to avoid any risk associated with said switching.

During the supply by an active group, the method 300 comprises a regulation phase 306 carried out within each passive group.

To this end, for each passive group, a step 306₁ carries out a supply from a module of the passive group:
of a heating resistor of each module of the passive group,
and optionally, of an auxiliary device of the vehicle.

The supplying module of the passive group is called operational module and all the other modules of the passive group are called passive modules.

The remaining charge level (RCL) of the operational module of the passive group is monitored during the supply step 306₁. Then, as a function of a predetermined rule, a step 306₂ carries out a change-over of the operational module within the passive group.

The change-over of the operational module, during step 306₂, can be carried out as a function of the remaining charge levels (RCL) of each module of the passive group and of the maximum charge capacity (MCC) of a module of the passive group.

In particular, the change-over of the operational module within a passive group is carried out when the RCL of the operational module becomes less than or equal to the RCL of a module by a predetermined value, which is equal to:
5% of the MCC of a module when all the modules of the passive group have a RCL greater than 70% of the MCC;
4% of the MCC of a module when at least one module of the passive group has a RCL comprised between 50% and 70% of the MCC;
3% of the MCC of a module when at least one module of the passive group has a RCL comprised between 30% and 50% of the MCC; and
2% of the MCC of a module when at least one module of the passive group has a RCL less than 30% of the MCC.

In the case of an electric vehicle, such as the bus 100 in FIG. 1, the change-over step 306₂ is preferentially carried out while the vehicle is stationary, in order to avoid any risk associated with said switching.

The regulation phase 306 can be carried out in order to maintain the temperature of the modules of the passive group above a predetermined value, such as for example 80° C. In this case, during the regulation phase 306, the operational module supplies the heating resistor of each module of the passive group, including its own.

In addition or alternatively, the regulation phase 306 can be carried out in order to balance the remaining charge level (RCL) of the modules of the passive group. In this case, during the regulation phase 306, the operational module can supply the heating resistor of each module of the passive group, and/or an auxiliary device external to the passive group.

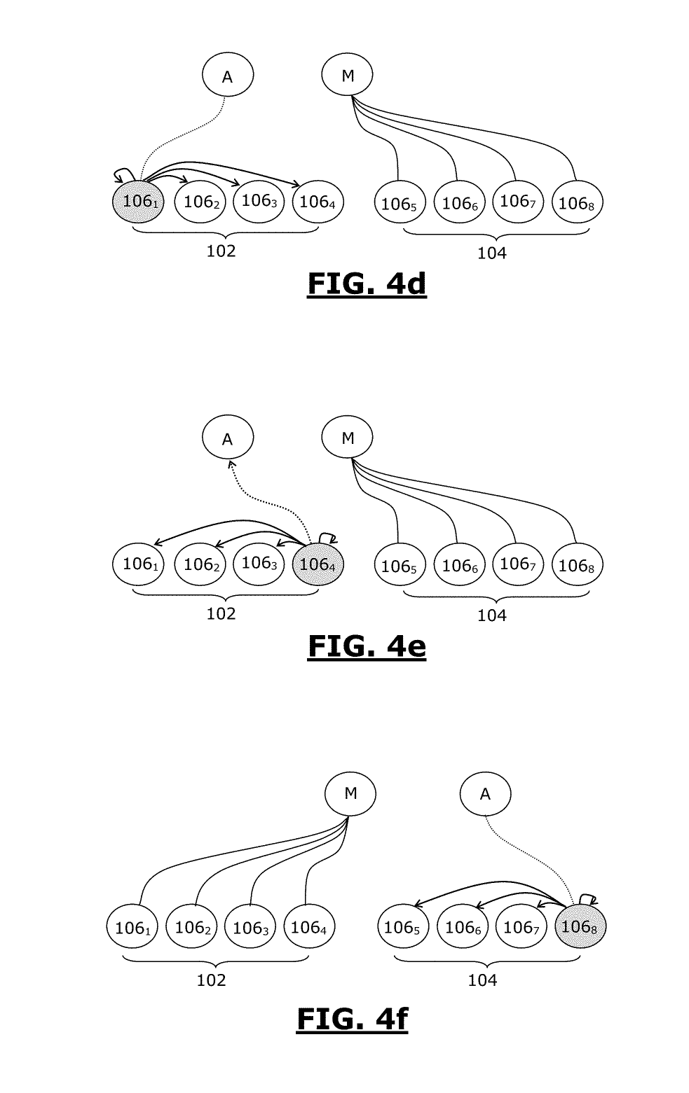

FIGS. 4a-4f are representations of an example of the application of the method 300 in FIG. 3 in the case of the vehicle 100 in FIG. 1.

The motor “M” of the vehicle 100 is supplied, alternately, by groups 102 and 104. Thus:
in FIGS. 4a-4c, the motor M is supplied by the group 102, then
in FIGS. 4d-4e, the motor M is supplied by the group 104, next
in FIG. 4f, the motor M is again supplied by the group 102.

With reference to FIGS. 4a-4c, the active group supplying the motor is the group 102 and the group 104 is the passive group. Regulation is carried out within the group 104. During this regulation, all the modules 106s-106a of the passive group 104, and optionally an auxiliary device marked “A” are supplied by a module, called operational module, chosen from within the passive group 104. This functional module is changed over such that:
in FIG. 4a, the operational module of the passive group 104 is the module 106₅, then
in FIG. 4b, the operational module of the passive group 104 is the module 106₆, then
in FIG. 4c, the operational module of the passive group 104 is the module 106₇.

With reference to FIGS. 4d-4e, the active group supplying the motor is the group 104 and the group 102 is the passive group. Regulation is carried out within the group 102. During this regulation, all the modules 106₁-106₄ of the passive group 102, and optionally an auxiliary device marked “A” are supplied by a module, called operational module, chosen from within the passive group 102. This functional module is changed over such that:
in FIG. 4d, the operational module of the passive group 102 is the module 106₁, then
in FIG. 4e, the operational module of the passive group 102 is the module 106₄.

With reference to FIG. 4f, the active group supplying the motor is again the group 102 and the group 104 is again the passive group. Regulation is carried out within the passive group 104. During this regulation, all the modules 106₅-106₈ of the passive group 104, and optionally an auxiliary device marked “A” are supplied by a module, called operational module, chosen within the passive group 104. In FIG. 4f, this operational module is the module 106₈.

Of course, the invention is not limited to the examples detailed above. In particular, the number of storage modules, the number of groups of modules, and the number of modules per group are not limited to those given in the examples described above, and correspond to the maximum number of energy storage modules depending in particular on the weight of the vehicle and the desired range of the vehicle.

1. A method for managing a plurality of rechargeable electrical energy storage modules in an electric vehicle, said modules each comprising at least one rechargeable electrochemical battery, and being arranged in parallel with one another, said method comprising:
separating said modules into at least two groups; and
supplying from one of said groups at a time;
said method comprising, during supplying by a group, called active group, a phase, called regulation phase, within at least one group, called passive group, other than the active group, said regulation phase comprising supplying at least one module, called passive module, of said passive group by at least one other module, called operational module, of said passive group.

2. The method according to claim 1, characterized in that the regulation phase of a passive group carries out temperature maintenance of at least one of the modules of said passive group.

3. The method according to claim 1, characterized in that the regulation phase of a passive group carries out balancing of the remaining charge level of at least one of the modules of said passive group.

4. The method according to claim 1, characterized in that for at least one passive group, the regulation phase comprises a change-over, in particular in turn, of the operational module within said passive group.

5. The method according to claim 4, characterized in that the change-over is carried out as a function of the remaining charge level of each of the modules of the passive group.

6. The method according to claim 4, characterized in that the change-over is carried out when the remaining charge level of the operational module becomes less than or equal to the remaining charge level of another module of the passive group, by a first predetermined value.

7. The method according to claim 1, characterized in that it comprises switching the supply from one group to another, carried out when the remaining charge level of the active group is less than or equal to the remaining charge level of a passive group, by a second predetermined value.

8. The method according to claim 7, characterized in that the second predetermined value is variable as a function of the remaining charge level of each group.

9. The method according to claim 1, characterized in that each group comprises one and the same number of module.

10. The method according to claim 9, characterized in that the operational module of the passive group is used for supplying an auxiliary device within the vehicle.

11. A system for managing a plurality of rechargeable electrical energy storage modules in an electric vehicle, said modules each comprising at least one rechargeable electrochemical battery, and being arranged in parallel with one another, said system comprising:
for each module, a means for individual connection/disconnection, making it possible to place said module on discharge independently of the other modules, and
at least one controller for controlling, directly or indirectly, each of said connection/disconnection means;
said controller being configured in order to implement all the steps of the method according to claim 1.

12. An electric vehicle with a plurality of on-board rechargeable electrical energy storage modules supplying said vehicle, said modules each comprising at least one rechargeable electrochemical battery, and arranged in parallel with one another, said modules being managed:
according to the method comprising:
separating said modules into at least two groups; and
supplying from one of said groups at a time;
said method comprising, during supplying by a group, called active group, a phase, called regulation phase, within at least one group, called passive group, other than the active group, said regulation phase comprising supplying at least one module, called passive module, of said passive group by at least one other module, called operational module, of said passive group; or
by a system according to claim 11.

13. The vehicle according to claim 12, characterized in that it is a public transport vehicle of the bus, coach or tired tram type.

14. The vehicle according to claim 12, characterized in that switching the supply from one group to another is carried out when the vehicle is stationary.
